(19) United States
(12) Patent Application Publication
(10) Pub. No.: US 2005/0135370 A1
(43) Pub. Date: Jun. 23, 2005

(54) Network printer and method of setting internet protocol address thereof

(76) Inventor: Woo-chang Kim, Suwon-si (KR)

Correspondence Address: STANZIONE & KIM, LLP, 1740 N STREET, N.W., FIRST FLOOR, WASHINGTON, DC, 20036, US

(21) Appl. No.: 11/001,238

(22) Filed: Dec. 2, 2004

(30) Foreign Application Priority Data
Dec. 5, 2003 (KR) 2003-87988

(51) Int. Cl. H04L 12/56

(52) U.S. Cl. 370/392

(57) ABSTRACT

A network printer and a method of setting an internet protocol (IP) address of a network printer in which an IP address unused in other network devices is set using a ping test and a network port scan test when an IP address of the network printer is inputted. The method includes receiving the IP address of the network printer inputted by a user, examining whether the inputted IP address is used in other network devices, and requesting the user to input another IP address, if the inputted IP address is used in other network devices. Further, the examining operation includes performing a ping test using the input IP address, and if the ping test has not performed successfully, performing a network port scan test to determine whether network ports of the other network devices are open, using the inputted IP address.

### CROSS-REFERENCE TO RELATED APPLICATIONS

This application claims the priority of Korean Patent Application No. 2003-87988, filed on Dec. 5, 2003, in the Korean Intellectual Property Office, the disclosure of which is incorporated herein in its entirety by reference.

### BACKGROUND OF THE INVENTION

1. Field of the Invention

The present general inventive concept relates to a network printer, and more particularly, to a method of setting an internet protocol (IP) address of a network printer which is not used in other network devices, using a ping test and a network port scan test when the IP address of the network printer is inputted.

2. Description of the Related Art

Generally, an IP address should be assigned to a network printer in order to use the network printer. One example of a method of setting such an IP address is disclosed in U.S. Pat. No. 5,724,510.

FIG. 1 is a flowchart of a conventional IP address setting method. Referring to FIG. 1, in operation S10, a user changes a current mode into a mode for inputting an IP address, and inputs an IP address of a network printer. Then, the user inputs a network mask in operation S12, and inputs a gateway in operation S14. Then, in operation S16, the user is requested to confirm whether data inputted by the user is correct, and it is determined whether the user confirms the inputted data. In operation S18, if it is determined that the user confirms the inputted data, a message that the input operation has been completed is displayed, and the IP address is stored in a storage unit of the network printer. If the user does not confirm the inputted data in operation S16, the operation S10 repeats.

As described above, in the conventional IP address setting method, it is not determined whether the IP address inputted by the user is used in other network devices. Therefore, if the IP address inputted by the user is used in other network devices, the input IP address conflicts with the used IP address, and correct print tasks cannot be performed to use the network printer.

### SUMMARY OF THE INVENTION

The present general inventive concept provides a method of setting an internet protocol (IP) address of a network printer capable of setting a usable IP address by examining whether the IP address of the network printer inputted by a user is used in other network devices.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept may be achieved by providing a network printer capable of setting a usable IP address by examining whether the IP address of the network printer inputted by a user is used in other network devices.

The foregoing and/or other aspects and advantages of the present general inventive concept may also be provided a method of setting an internet protocol (IP) address of a network printer. The method may include receiving the IP address of the network printer inputted by a user, examining whether the inputted IP address is used in other network devices, and requesting the user to input another IP address, if the inputted IP address is used in other network devices.

The examining of whether the inputted IP address is used in other network devices may include performing a ping test using the inputted IP address, and if the ping test has not performed successfully, performing a network port scan test in which opened network ports are tested using the inputted IP address.

The foregoing and/or other aspects and advantages of the present general inventive concept may also be achieved by providing a network printer including an input unit to receive an internet protocol (IP) address of the network printer from a user, a test unit to examine whether the inputted IP address is used in other network devices, and a requesting unit to request the user to input another IP address, if the inputted IP address is used in other network devices.

The test unit may comprise a unit to perform a ping test using the inputted IP address, and if the ping test has not performed successfully, to perform a network port scan test in which network ports are tested to determine whether the network ports are open, using the inputted IP address.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a flowchart of a conventional internet protocol (IP) address setting method;

FIG. 2 is a block diagram of a network printer according to an embodiment of the present general inventive concept;

FIG. 3 is a flowchart of an IP address setting method according to another embodiment of the present general inventive concept; and

FIG. 4 is a flowchart of an examining operation of whether an IP address is used in other network devices in the IP address setting method of FIG. 3.

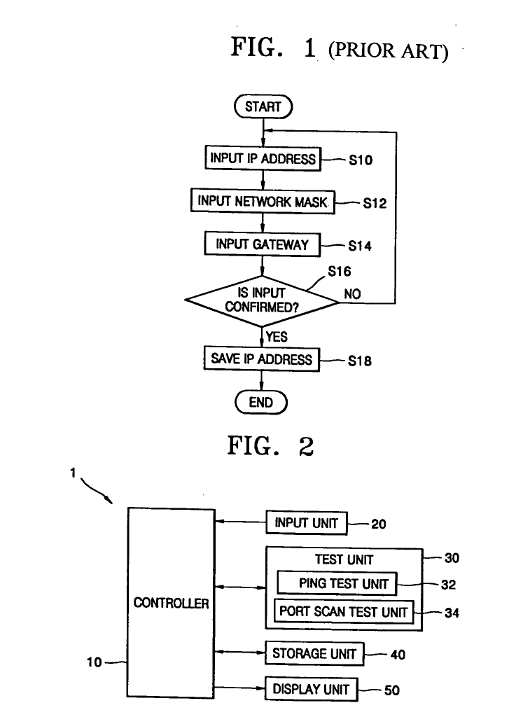

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

FIG. 2 is a block diagram of a network printer 1 according to an embodiment of the present general inventive concept. Referring to FIG. 2, the network printer 1 includes a controller 10, an input unit 20, a test unit 30, a storage unit 40, and a display unit 50. The test unit 30 includes a ping test unit 32 and a port scan test unit 34.

The input unit 20 receives an internet protocol (IP) address of the network printer 1 inputted by a user. Further, the input unit 20 can receive a network mask and a gateway.

The test unit 30 examines whether the input IP address is used in other network devices. The ping test unit 32 of the test unit 30 performs a ping test using the input IP address. The port scan test unit 34 of the test unit 30 performs a network port scan test in which network ports are tested to determine whether the network ports are open, using the input IP address. The test unit 30 performs the ping test using the input IP address, and if the ping test has not performed successfully, the test unit 30 performs the network port scan test in which the network ports are tested to determine whether the network ports are open. When the network ports are open, it is determined that the input IP address is used in other network devices.

The controller 10 generally controls the network printer 1. In particular, the controller 10 receives the IP address from the input unit 20, and sends the IP address to the test unit 30 to receive a test result from the test unit 30. Based on the test result, if the input IP address is used in other network devices, the controller 10 requests the user to input another IP address. On the other hand, based on the test result, if the input another IP address is not used in other network devices, the controller 10 stores the input another IP address in the storage unit 40.

Also, if the inputted IP address is used in other network devices, the controller 10 controls the display unit 50 to display a warning message to the user.

In the meantime, although the input unit 20 and the display unit 50 are shown to be included in the network printer 1, the input unit and the display unit 50 can be included in a computer connected to the network printer. Therefore, the IP address of the network printer can be inputted using the input unit of the computer, for example, a keyboard, and a warning message can be displayed on the display unit 50 of the computer, for example, on a monitor.

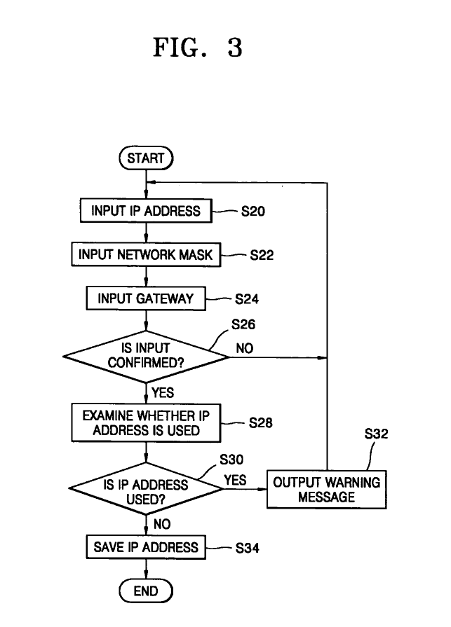

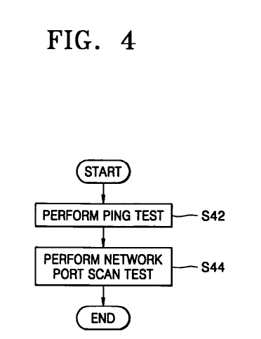

FIG. 3 is a flowchart of an IP address setting method according to another embodiment of the present general inventive concept, and FIG. 4 is a flowchart of an examining operation of whether an IP address is used in other network devices in FIG. 3. Hereinafter, the IP address setting method will be described with reference to FIGS. 3 and 4.

Referring to FIG. 3, in operation S20, a user changes a current mode into a mode for inputting an IP address, and the user inputs an IP address of a network printer. Then, the user inputs a network mask in operation S22, and the user inputs a gateway, in operation S24. Then, in operation S26, the user is requested to confirm whether data inputted by the user is correct, and it is determined whether the user confirms the input data. If the user does not confirm the input data, the operation S20 repeats.

If the user confirms the inputted data, it is examined whether the input IP address is used in other network devices in operation S28. As shown in FIG. 4, a ping test is performed using the IP address in operation S42, and a network port scan test is performed to determine whether network ports are open, using the input IP address in operation S44. The ping test can be performed using the input IP address, and only if the ping test has not performed successfully, the network port scan test is performed to determine whether network ports are open. When the network ports are open, it is determined that the input IP address is used in other network devices. Because it is relatively simply examined whether the input IP address is used in other network devices using the ping test, the ping test may be performed before the network port scan test is performed.

If it is found that the IP address inputted by the user is already used in other network devices by performing the ping test, it is not needed to perform the network port scan test. However, if it cannot be confirmed whether the IP address inputted by the user is already used in other network devices by performing the ping test, for example, if the ping test fails because no network devices use the IP address, or if routers of network devices prevent the ping test, it is needed to perform the network port scan test.

The network port scan test can be performed according to the following pseudo codes:

for ( I = 1; I < 65536; I++)
{

TCP connect for I port;
If( connection is successful ) return SUCCESS;
UCP connect for I port;
If( connection is successful ) return SUCCESS;

}

return FAIL;

As shown in the pseudo codes, in the network port scan test, transmission control protocol (TCP) connections are tested for ports 1 to 65535, and then user datagram protocol (UDP) connections are tested for ports 1 to 65535.

Therefore, it can be examined whether the IP address inputted by the user is used in other network devices using the network port scan test.

Based on the test result in operation S28, it is determined whether the IP address inputted by the user is used in other network devices in operation S30. If it is determined that the IP address inputted by the user is used in other network devices, a warning message that the input IP address is used in other network devices is outputted, in operation S32, and the operation S20 repeats, and the user is requested to input a second IP address. Meanwhile, if it is determined that the second IP address inputted by the user is not used in other network devices, a message that the input operation has been completed is displayed, and the input second IP address is stored in the storage unit 40 of the network printer.

Although the present general inventive concept is described in relation to the network printer, the present general inventive concept can be applied to network devices to which an IP address is assigned to, for example, network multi-functional devices (MFDs), and network scanners. The network MFD is a device that includes functions of a scanner, a printer, and a copier.

As described above, this invention makes it possible to set an IP address which is not used in other network devices, since it is found whether the IP address inputted by a user is used in other network devices.

Therefore, a user can set a non-conflicted IP address to a network printer, and normal print tasks can be performed.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A method of setting an internet protocol (IP) address of a network printer, the method comprising:
receiving an input IP address of a network printer inputted by a user;
examining whether the input IP address is used in other network devices; and
requesting the user to input another IP address, if the inputted IP address is used in other network devices.

2. The method of claim 1, wherein the examining of whether the input IP address is used in other network devices comprises performing a ping test using the input IP address.

3. The method of claim 1, wherein the examining of whether the input IP address is used in other network devices comprises performing a network port scan test to determine whether network ports of the other network devices are open, using the input IP address.

4. The method of claim 1, wherein the examining of whether the input IP address is used in the other network devices comprises performing a ping test using the input IP address, and if the ping test has not performed successfully, performing a network port scan test to determine network ports of the other network devices are open, using the input IP address.

5. The method of claim 1, further comprising:
storing the input another IP address, if the input another IP address is not used in other network devices.

6. The method of claim 1, wherein the operation of requesting comprises outputting a warning message that the inputted IP address is used in other network devices.

7. A network printer apparatus comprising:
an input unit to receive an internet protocol (IP) address of a network printer inputted by a user;
a test unit to examine whether the input IP address is used in other network devices; and
a requesting unit to request the user to input another IP address, if the input IP address is used in the other network devices.

8. The network printer apparatus of claim 7, wherein the test unit comprises a ping test unit to perform a ping test to determine whether the input IP address is used in the other network devices, using the inputted IP address.

9. The network printer apparatus of claim 7, wherein the test unit comprises a network port scan test unit to perform a network port scan test to determine whether network ports of the other network devices are open, using the input IP address.

10. The network printer apparatus of claim 7, wherein the test unit comprises a unit to perform a ping test to determine whether the input IP address is used in other network devices, using the inputted IP address, and if the ping test has not performed successfully, to perform a network port scan test to determine network ports of the other network devices are open, using the input IP address.

11. The network printer apparatus of claim 7, further comprising:
a storage unit to store the input another IP address if the input another IP address is not used in other network devices.

12. The network printer apparatus of claim 7, further comprising:
a display unit to output a warning message if the input IP address is used in other network devices.

13. A network printer apparatus to set an internet protocol (IP) address of a network printer, comprising:
an input unit to receive an input internet protocol (IP) address of a network printer;
a test unit to examine whether the input IP address is used in other network devices; and
a control unit to selectively store the input IP address as an IP address of the network printer according to the examination of the test unit.

14. The network printer apparatus of claim 13, wherein the control unit stores the input IP address as the IP address of the network in a storage unit, if the input IP address is not used in the other network devices.

15. The network printer apparatus of claim 13, wherein the control unit prevents the input IP address from being stored as the IP address if the input IP address is used in the other network devices.

16. The network printer apparatus of claim 13, wherein the control unit comprises a requesting unit to request a user to input another IP address if the input IP address is used in the other network devices.

17. The network printer apparatus of claim 16, wherein the control unit does not the input IP address as the IP address of the network printer.

18. The network printer apparatus of claim 16, wherein the test unit examines whether the input another IP address is used in other network devices.

19. The network printer apparatus of claim 18, wherein the control unit stores the input another IP address as the IP address of the network printer according to the examination of the test unit on the another input IP address.

20. The network printer apparatus of claim 13, wherein the input unit receives an input another IP address when the input IP address is used in the other network devices.

21. The network printer apparatus of claim 20, wherein the control unit does not the input IP address as the IP address of the network printer.

22. The network printer apparatus of claim 20, wherein the test unit examines whether the input another IP address is used in other network devices.

23. The network printer apparatus of claim 22, wherein the control unit stores the input another IP address as the IP address of the network printer according to the examination of the test unit on the input another IP address.

24. The network printer apparatus of claim 20, wherein the test unit comprises:
a ping test unit to examine whether the input IP address is used in other network devices using a ping test, and whether the input another IP address is used in other network devices using the ping test; and
a port scan test unit to examine whether the input IP address is used in other network devices using a network port scan test, and whether the input another IP address is used in other network devices using the network port scan test.

25. The network printer apparatus of claim 13, further comprising:
a display unit to display a warning message indicating whether the input IP address is used in the other network devices.

26. The network printer apparatus of claim 25, wherein the display unit displays the warning message when the control unit does not store the input IP address as the IP address of the network printer according to the examination of the test unit.

27. The network printer apparatus of claim 13, wherein the test unit comprises:
a ping test unit to examine whether the input IP address is used in other network devices using a ping test; and
a port scan test unit to examine whether the input IP address is used in other network devices using a network port scan test.

28. The network printer apparatus of claim 13, wherein the network device is connected to the other network devices through a network, and the stored IP address is used to access the other network devices from the network device.

29. The network printer apparatus of claim 13, wherein the network device is connected to the other network devices through a network, and the stored IP address is used to access the the network device from the other network devices.

30. The network printer apparatus of claim 13, wherein the input IP address is not stored as the IP address without the examination of the test unit.

31. A method of setting an internet protocol (IP) address of a network printer, the method comprising:
receiving an input internet protocol (IP) address of a network printer;
examining whether the input IP address is used in other network devices; and
selectively storing the input IP address as an IP address of the network printer according to the examination of the test unit.

32. The method of claim 31, further comprising:
preventing the input IP address from being stored as the IP address of the network printer when the input IP address is used in the other network devices.
receiving an input another IP address when the input IP address is used in the other network devices;
examining whether the input another IP address is used in the other network devices; and
storing the input another IP address as the IP address of the network printer according to the examination of the test unit on the input another IP address.

33. The method of claim 32, further comprising:
displaying a message indicating that the input IP address is used in the other network devices.

34. The method of claim 33, further comprising:
displaying a request message through which a user inputs the input another IP address.
